(19) United States
(12) Patent Application Publication
(10) Pub. No.: US 2007/0204858 A1
(43) Pub. Date: Sep. 6, 2007

(54) Gas cooking appliance and control system

(75) Inventor: Kevin Abelbeck, Dallas, TX (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: The Brinkmann Corporation, Dallas, TX (US)

(21) Appl. No.: 11/701,602

(22) Filed: Feb. 1, 2007

Related U.S. Application Data
(60) Provisional application No. 60/758,648, filed on Feb. 22, 2006.

(51) Int. Cl. F24C 3/00; A47J 37/00

(52) U.S. Cl. 126/41 R

(57) ABSTRACT

A gas cooking appliance for connection to a source of gas is provided, having a burner, a cooking surface, a frame adapted to support the burner and the cooking surface, and a first valve in communication with a second valve. The first valve selectively enables flow of gas from the source to the second valve, while the second valve is adapted to provide a variably controlled output to the burner.

### CROSS-REFERENCE TO RELATED APPLICATION DATA

Priority is claimed under 35 U.S.C. § 119(e) to U.S. Provisional Application No. 60/758,648, filed on Feb. 22, 2006, which is incorporated by reference herein.

### FIELD OF THE INVENTION

The present invention generally relates to gas cooking appliances and, more particularly, to gas cooking appliances adapted to variably control gas flow and heat output.

### BACKGROUND OF THE INVENTION

Since mankind discovered the advantages of cooking food, the cooking process has been continuously evolving. Fire was the primary ingredient making food more palatable and less hazardous to our digestive systems. Though few people today consistently cook over open campfires, we do cook over an open flame, both in the kitchen and the backyard. Natural gas (NG), which is primarily comprised of methane (CH₄), and liquid propane, or LP (C₄H₈), are common in households across this country and around the world. Throughout this disclosure it is understood that “gas” is a generic term for both primary systems NG and LP, as well as lesser-used butane (C₄H₁₀), ethane (C₂H₆) and any other carbon-hydrogen compositions.

Gas cooking, as opposed to electric power, has many advantages. The first is efficiency. When a flame is produced, heat follows instantaneously. With electric systems, an electric current flows through a resistive coil, thereby producing heat. In a typical electric range, a cook-top “burner” can take several seconds or even a minute or more to come to the set temperature. The same process is exaggerated greatly in the cool-down phase. The resistive metal of the coil can be relatively well insulated within the appliance and therefore it commonly takes several minutes to cool back down to ambient temperature. With gas, when the gas flow is stopped, the flame is immediately extinguished. Any food supportive structure subjected to the heat, such as a cooking grate, usually has a high surface area to volume ratio and therefore rapidly cools in the air.

Outdoor barbecues also provide food taste and texture that are difficult to mimic by indoor systems. Though some people prefer charcoal as the energy source, NG and LP are ever more gaining popularity due to speed and ease of use. The challenges of outdoor cooking include a great variation in air temperature, wind and humidity. To complicate this, the temperature of the cooking surface is specific to the type of food, and every time the grill hood is opened, a great deal of heat rapidly escapes. It would be desirable to have a system that senses the temperature of the cooking surface and adjusts the gas output rapidly to maintain the set temperature. A typical thermostat, which has only “on-off” positions, does not adequately hold the cooking surface temperature within a relatively small range. Given wind, outside temperature extremes and occasionally removing the top of the cooker and letting the heat escape, the environmental conditions are too extreme. Using an “on-off” system would constantly cause the gas flame to cycle on and off. The system would need to include a throttled or adjustable gas valve.

It should, therefore, be appreciated that there is a need for a gas cooking appliance that senses the temperature of a cooking surface and adjusts the gas flow and heat output to maintain the set temperature. The present invention fulfills this need and others.

### SUMMARY OF THE INVENTION

The present invention provides a cooking appliance incorporating a burner, a cooking surface, a frame adapted to support the burner and the cooking surface, and a first valve in communication with a second valve. The first valve selectively enables a flow of a gas from a source to the second valve, while the second valve is adapted to provide a variably controlled output to the burner.

In a presently preferred embodiment of the invention, the first valve may be a two-way valve and is preferably a two-way normally closed solenoid valve. The first valve selectively enables a flow of gas preferably by way of at least one switch disposed on a front panel of the appliance. This switch is preferably electrically connected to a power supply and the first valve. The second valve preferably includes a core that is received by a body, such that the relative position between the core and the body determines the flow through the second valve.

An actuator, such as an electric motor or electric gear motor, may be in communication with the second valve. Preferably, the actuator is in communication with the core of the second valve, and is adapted to displace the core, whereby movement of the core alters gas flow through the valve. At least one switch is preferably disposed on a front panel of the appliance, and is electrically connected to the power supply and the actuator.

The output from the second valve to the burner may include a stem or a tube with a burner tip mounted to a distal end. The device may also include an ignition system adapted to ignite the gas adjacent to the burner.

The gas cooking appliance of the present invention further may have a thermal control, which includes a thermal sensor mounted adjacent to the cooking surface. A switch is preferably adapted to input a set temperature value. An actuator is in communication with the second valve and a control system is adapted to drive the actuator relative to output from the thermal sensor and the set temperature value. The thermal sensor may be a bare wire bead thermocouple, a thermocouple probe, an infrared temperature sensor, a resistance temperature detector (RTD) or any other suitable temperature sensing device. The thermocouple is preferably a nickel-chromium/nickel-aluminum (Type K) bare wire bead thermocouple housed in a tube, such as a stainless steel tube with a plurality of holes on one side toward the middle of the tube and with a support plug housed within the tube and supporting a free end of the wire bead thermocouple. The plug is preferably comprised of a block with a center bore to receive the thermocouple. The sensor may also be a thermocouple probe, which may be housed in a cover mounted to the frame.

The control system preferably includes a processor adapted to monitor the Current Temperature (T_{C}) data from the thermal sensor and compare to the Set Temperature (T_{S}) value. The control system then provides a control output to the actuator based on temperature history and Current Temperature (T_{C}). This control output can be Maximum Flame (F_{MAX}) when the Current Temperature (T_{C}) is less than a Bottom Range Limit (BRL) and the output is Minimum Flame (F_{MIN}) when the Current Temperature (T_{C}) is greater than a Top Range Limit (TRL). The control output is unchanged when the Current Temperature (T_{C}) is between a Lower Range Limit (LRL) and an Upper Range Limit (URL).

The control output may be derived from a control algorithm when the Current Temperature (T_{S}) is between the Bottom Range Limit (BRL) and the Lower Range Limit (LRL) or between a Top Range Limit (TRL) and the Upper Range Limit (URL). This control algorithm may include the first derivative of the function of previous Current Temperature (T_{C}) values, the Current Temperature (T_{C}) value and the difference between the Current Temperature (T_{C}) value and the Set Temperature (T_{S}) value.

An exemplary method for cooking according to the invention, for use with a cooking appliance as disclosed herein, includes the steps of opening the first valve, actuating the igniter, thereby generating a flame at the burner, and altering the second valve to alter the flow of gas to the burner. The method may also include the steps of inputting a set temperature, monitoring data from the thermal sensor by the control system and adjusting the gas flow by the actuator relative to data from the thermal sensor and the set temperature.

For purposes of summarizing the invention and the advantages achieved over the prior art, certain advantages of the invention have been described herein above. Of course, it is to be understood that not necessarily all such advantages can be achieved in accordance with any particular embodiment of the invention. Thus, for example, those skilled in the art will recognize that the invention can be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following description of the preferred embodiments and drawings, the invention not being limited to any particular preferred embodiment(s) disclosed.

### BRIEF DESCRIPTION OF THE DRAWINGS

Embodiments of the present invention will now be described, by way of example only, with reference to the following drawings, in which:

FIG. 1 is an isometric view of a cooking appliance incorporating a control system in accordance with the present invention.

FIG. 2 is an isometric partial upper left view of a cook-box, display and side tables of the cooking appliance of FIG. 1.

FIG. 3 is an isometric partial bottom right view of a cook-box, display and side tables of the cooking appliance of FIG. 1.

FIG. 4 is an isometric view of the exterior of a four-output control box for a cooking appliance of a control system.

FIG. 5 is an isometric view of the four-output control box of FIG. 4, with the top cover removed.

FIG. 6 is an isometric view of the interior of the four-output control box of FIG. 4.

FIG. 7 is an isometric view of the interior of the four-output control box of FIG. 4, with one gas valve and optical disk removed.

FIG. 8 is an isometric view of a gas manifold of the four-output control box of FIG. 4.

FIG. 9 is a front view of a gas manifold of the four-output control box of FIG. 4.

FIG. 10 is a sectioned view of a gas manifold of the four-output control box of FIG. 4.

FIG. 11 is a disjoined partial isometric view of a gas valve housed in the control box if FIG. 4.

FIG. 12 is a partial isometric view of a gas valve, one gear motor and gas valve assembly with a single notch optical disk mounted to a motor shaft.

FIG. 13 is a partial isometric view of the assembly from FIG. 12 that shows the internal design of the manifold.

FIG. 14 is a left lower isometric view of the grill head of FIG. 1, with the front of the firebox and covers removed.

FIG. 15 is a left lower front isometric view at a steep angle of the grill head of FIG. 1, with the front of the firebox and covers removed.

FIG. 16 is a left lower rear isometric view of the grill head of FIG. 1, with the front of the firebox and covers removed.

FIG. 17 is an upper right rear isometric view of the burners, thermal control tubes, control box and display of the cooking appliance of FIG. 1.

FIG. 18 is lower right front isometric view of the burners, thermal control tubes, control box and display of the cooking appliance of FIG. 1.

FIG. 19 is a front view of the display of the cooking appliance of FIG. 1.

FIG. 20 is a sectioned view of the display of the cooking appliance of FIG. 1.

FIG. 21 is a isometric view of the PC boards of the display of FIG. 19.

FIG. 22 is a bottom view of a thermal control tube used in the cooking appliance of FIG. 1.

FIG. 23 is a bottom view of a thermal control tube used in the cooking appliance of FIG. 1.

FIG. 24 is a sectional view of the thermal control tube of FIG. 23.

FIG. 25 is a system logic flow chart of a cooking appliance using thermal control.

FIG. 26 is a graph illustrating a thermal control system.

FIG. 27 is an electrical schematic of a cooking appliance using thermal control.

FIG. 28 is a front view of a display of a cooking appliance using thermal control.

FIG. 29 is a front view of a display of a cooking appliance using manual control.

FIG. 30 is a flow chart of a manually controlled system of a cooking appliance.

FIG. 31 is an isometric view of a burner adjustment module of a cooking appliance.

FIG. 32 is an isometric view of a burner adjustment module of a cooking appliance.

FIG. 33 is a schematic of a control system for a cooking appliance.

### DETAILED DESCRIPTION OF THE INVENTION

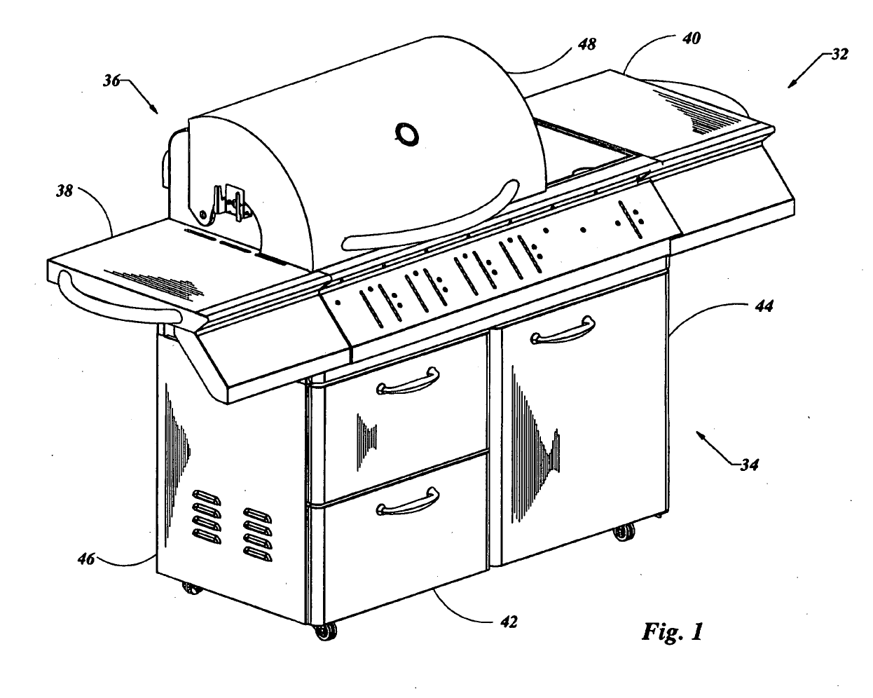

With reference to the illustrative drawings, and particularly to FIG. 1, there is shown a cooking appliance device in the form of a barbeque grill 32. A cart 34 is shown as the section under the grill head 36 with a left side table 38 and a right side table 40. The cart 34 can include drawers 42, doors 44 exclusively, in combination, or none at all. Here the cart 34 is closed by walls 46, drawers 42 and a door 44. This provides a closed space to store items such as a liquid propane (LP) tank for fuel for the burners 54. A lid 48 covers a firebox 50 of the grill head 36.

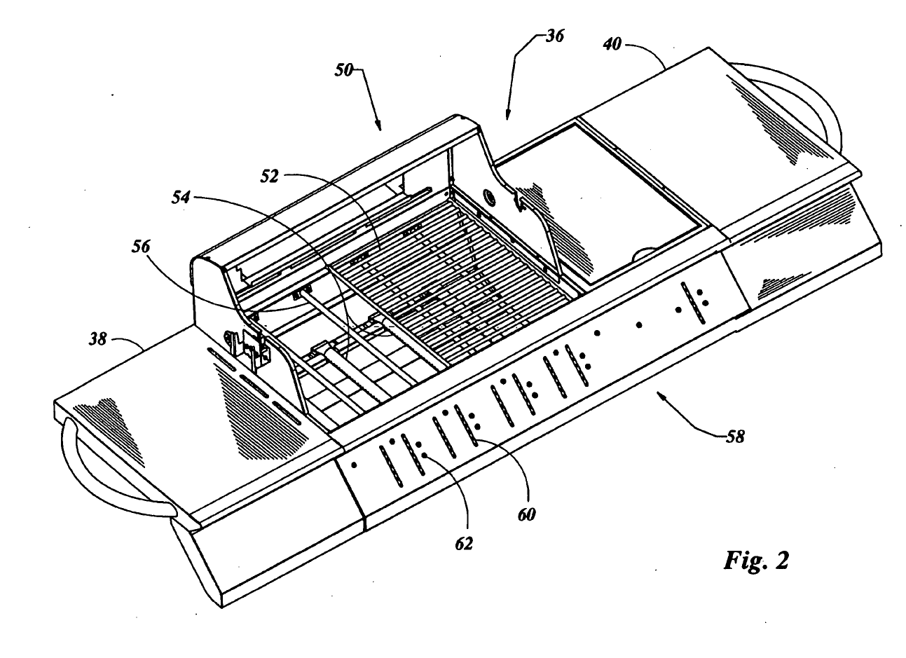

With reference to FIG. 2, the grill head 36 with the left and right side tables 38 and 40, respectively, is shown with the firebox 50 exposed for illustrative purposes. At the top of the firebox 50 is a cooking grate 52. In use there would be a second cooking grate 52 positioned adjacent to this, thereby covering the top of the firebox 50 at a height near the top of the side tables 38 and 40. These cooking grates 52 provide a “cooking surface.” The specific construction of the cooking grates 52 is not critical. Four burners 54 are shown in the primary location, or in the firebox 50. Again the construction of tube burners, as shown here, or cast burners or the number of burners 54 is not critical to the novelty of the invention. Any and all forms of burners 54 and cooking grates 52 can be used in combination with the present invention.

Directly under the cooking grate 52 and above each burner 54 is a thermal control tube 56. This is one embodiment of a thermal sensor 224 to measure the heat above each burner 54 or more specifically in a particular zone of the firebox 50, specifically near the cooking surface or cooking grate 52. In one embodiment of the invention the temperature of each zone is monitored by the corresponding thermal sensor 224 housed within each thermal control tube 56 mounted above that burner 54. In another embodiment, the thermal sensors are not used, and therefore the firebox 50 would be the same with these thermal control tubes 56 removed.

The cooking appliance includes a display 58 with a series of light indicators 60 and button switches 62. The interaction between the grill 32 and the user is enabled by the button switches 62 with visual feedback given by the light indicators 60. In this disclosure, the light indicators 60 are shown as vertical. This is only one embodiment and it is understood that the layout of this visual feedback is limited only by imagination.

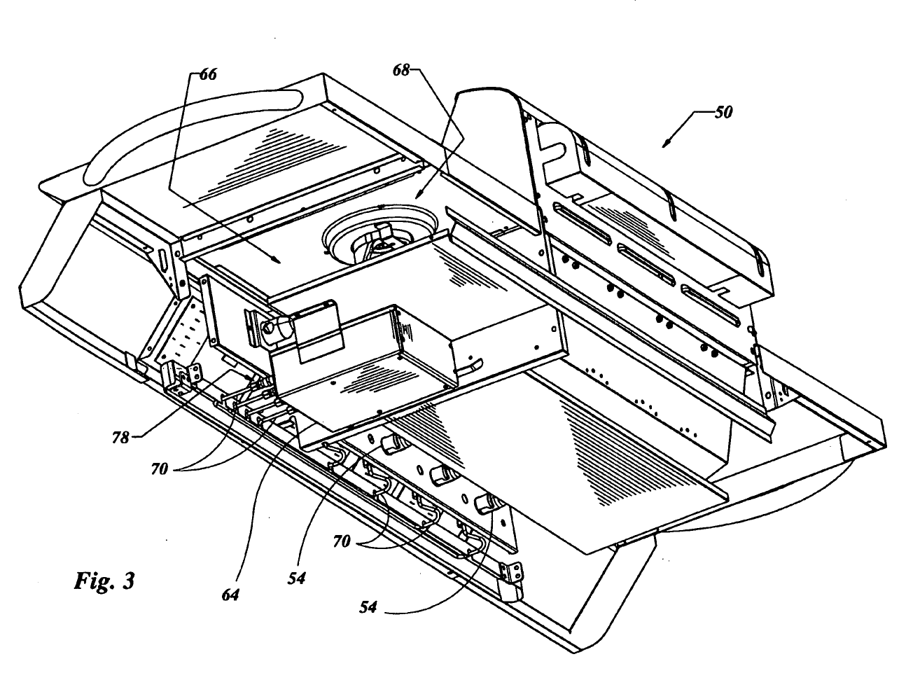

Another view of the firebox 50 is shown from the bottom, right rear in FIG. 3. A control box 64 is mounted to the underside of a frame 66. In this case the box 64 is mounted under a side burner 68, but that is not critical. A location away from excessive heat from the burners 54 and near the firebox 50 is preferable. The box 64 houses the control system for gas flow to the burners 54. This is further shown by the presence of a gas line 70 extending from separate ports 78 on the box 64, one to each of the burners 54 mounted at the base of the firebox 50.

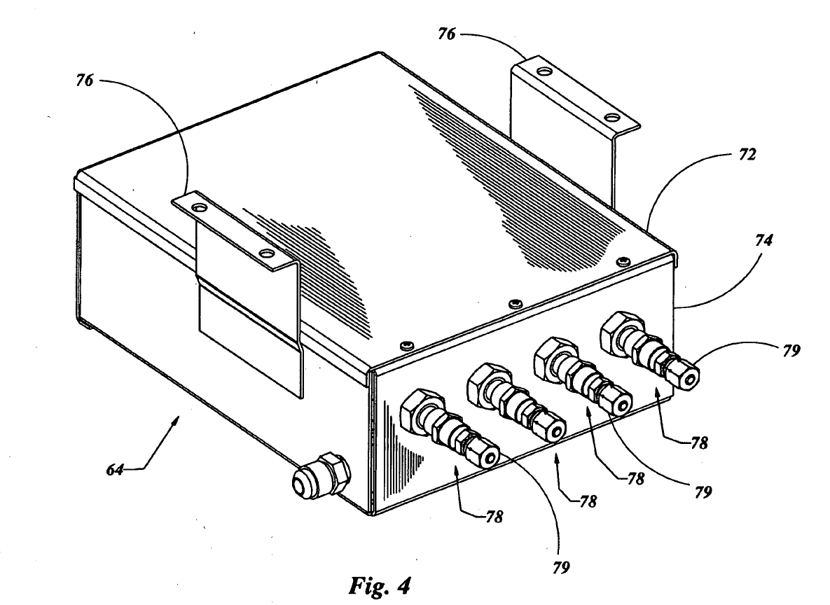

With reference to FIG. 4, the control box 64 has a top cover 72 and a base 74. The cover 72 and the base 74 act to house and protect the internal components of the control box 64. The legs 76 act as mounting brackets to support the box 64 to the frame 66 of the grill 32 or cooking appliance. In a preferred embodiment, four ports 78 exist, one to each of the four burners 54. The ports 78 can include one or more fittings 79 to enable a substantially airtight connection from the box 64 to each burner 54. In this embodiment compression line fittings are used. Aluminum, brass, copper, and other such tubing can be used to make a substantially airtight seal and pathway to the burners 54.

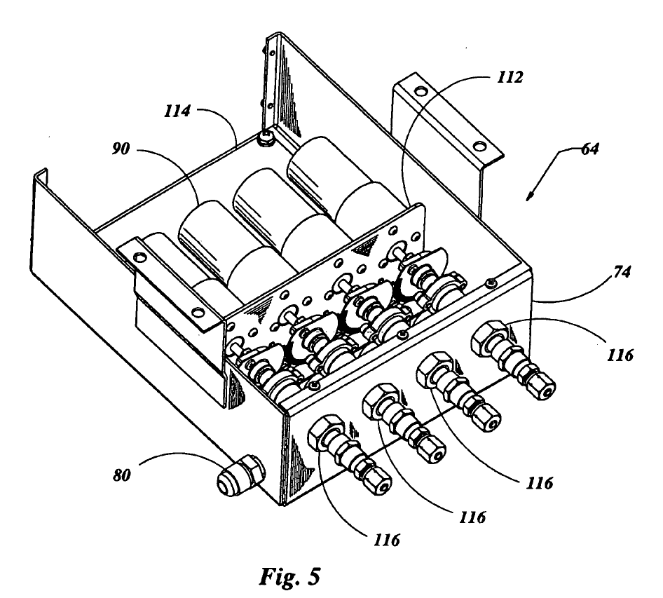

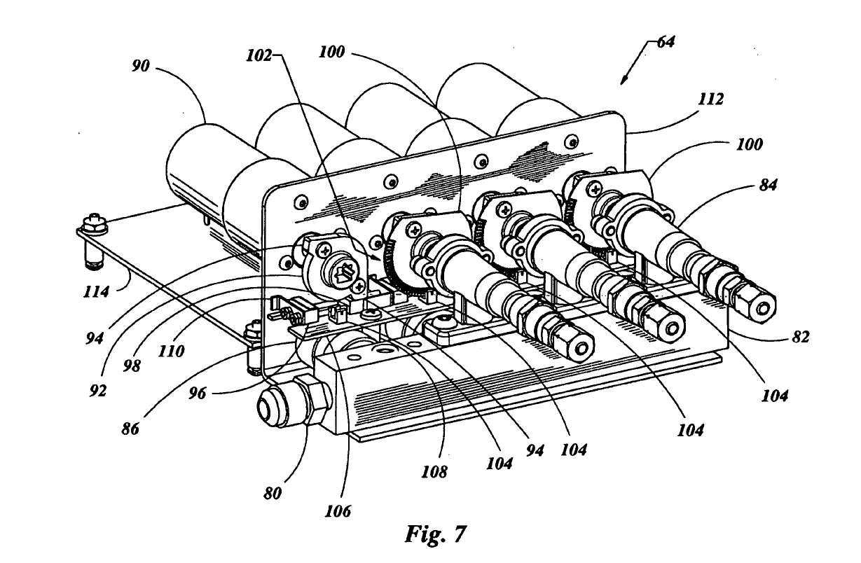

With references now to FIGS. 5-7, an intake fitting 80 provides gas input from a LP tank or NG source 330. Gas from this source 330 enters a manifold 82 that allows fluid communication between the source 330 and a second valve 84. A first valve 86 is also mounted to the manifold 82. The first valve 86 is preferably a normally closed solenoid valve. As such, in the absence of power, the first valve 86 is closed. This prevents any gas flow from out of the manifold 82 to the second valves 84. In a preferred embodiment, there are four first valves 86, one in series with each second valve 84.

The second valve 84 is a variably controlled valve, such that the flow through the second valve 84 is controlled by rotating the core 144, by way of the input shaft 88. The input shaft 88 is connected to an actuator 90 by a coupling 92. The coupling 92 has two distinct functions in this embodiment. First, it provides for smooth power transmission from the actuator 90, shown here as an electric gear motor, to the input shaft 88 of the second valve 84, in spite of normal misalignment due to manufacturing tolerances. Second, it indicates the position of the input shaft 88 and therefore the valve core 144, which controls gas flow. The coupling 92 has two extensions 94 on opposite sides of the coupling 92. The extensions 94 make contact with limit switches 96 and 98 to signal the minimum and maximum flow positions for the second valve 84. To determine all points in between minimum and maximum, an optical disk 100 is used. The disk 100 is mounted to the coupling 92 and includes a plurality of slits to make a slotted portion 102 in the disk 100.

The disk 100 is mounted such that the slotted portion 102 runs between two ears of an optical sensor 104. The sensor 104 has a light source and a light sensor. When the light is blocked by the teeth of the slotted portion 102 of the disk 100, an electronic gate is closed. When a disk 100 rotates enough to allow light to pass through one of the slots, the gate is opened. The design of the width and spacing of the slots determines the amount of rotation of the input shaft 88 to the second valve 84 that corresponds to each pulse. Therefore each “electronic pulse” is a specific rotational distance. By counting the pulses, the amount of displacement is determined. Every time a limit switch is actuated, the minimum 96 or maximum 98 positions are realized and the electronic register is reset accordingly.

In a preferred embodiment, the optical sensors 104 and the limit switches 96 and 98 are mounted directly to a switch PC board 106. The switch PC board 106 is supported by standoffs 108 and can also include ears 110 mounted to a L-frame base 112. The main PC board 114 is mounted behind the L-frame base 112 but in communication with the switch PC board 106. The entire assembly that is mounted to the L-frame base 112 is secured to the base 74 by jam nuts 116. This enables all stresses presented to the exposed portions of the second valves 84 outside of the cover be transferred to the full assembly, allowing it to deflect rather than misalign any one second valve 84 from the corresponding actuator 90, optical disk 100, switches 96 & 98 and optical sensor 104. By mounting all critically aligned components to the same L-frame base 112, the aligned assembly and stability over time are greatly improved.

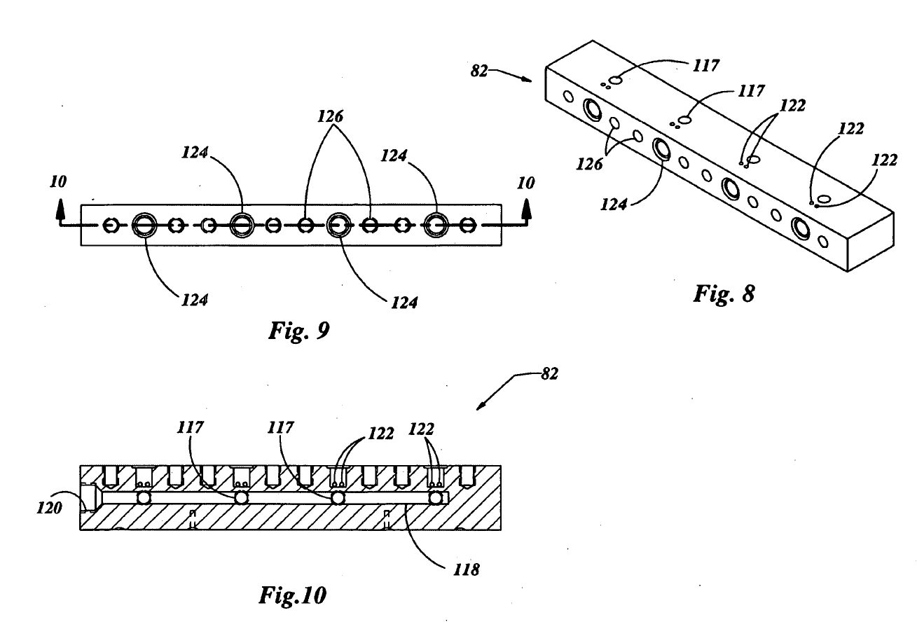

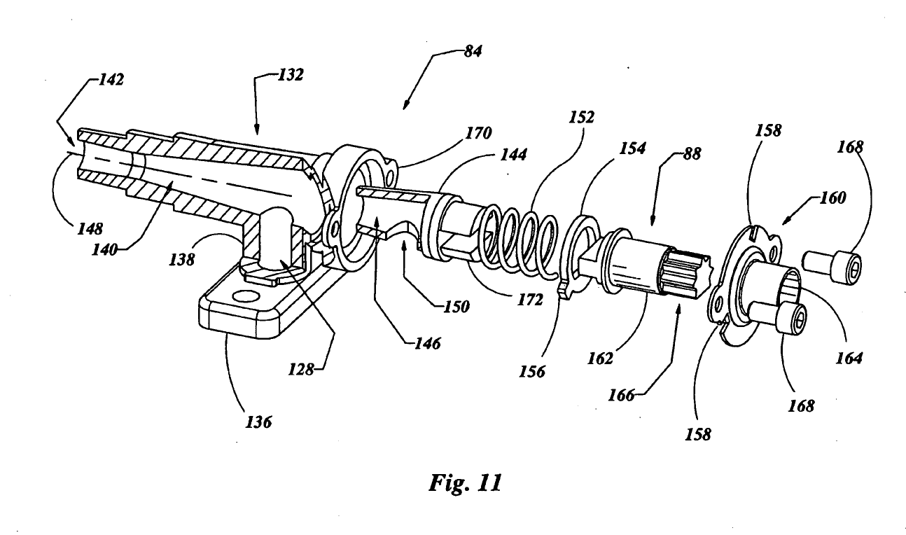

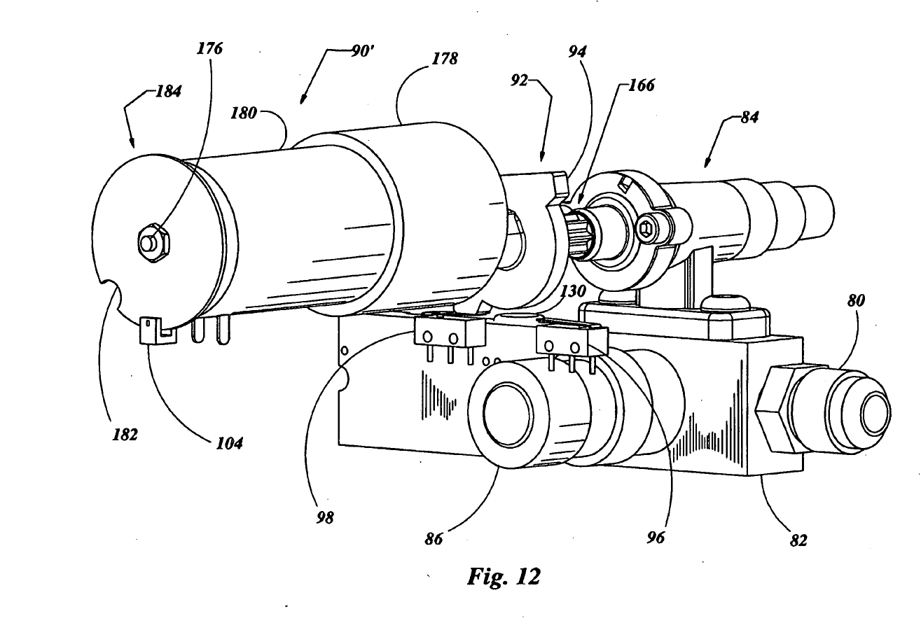

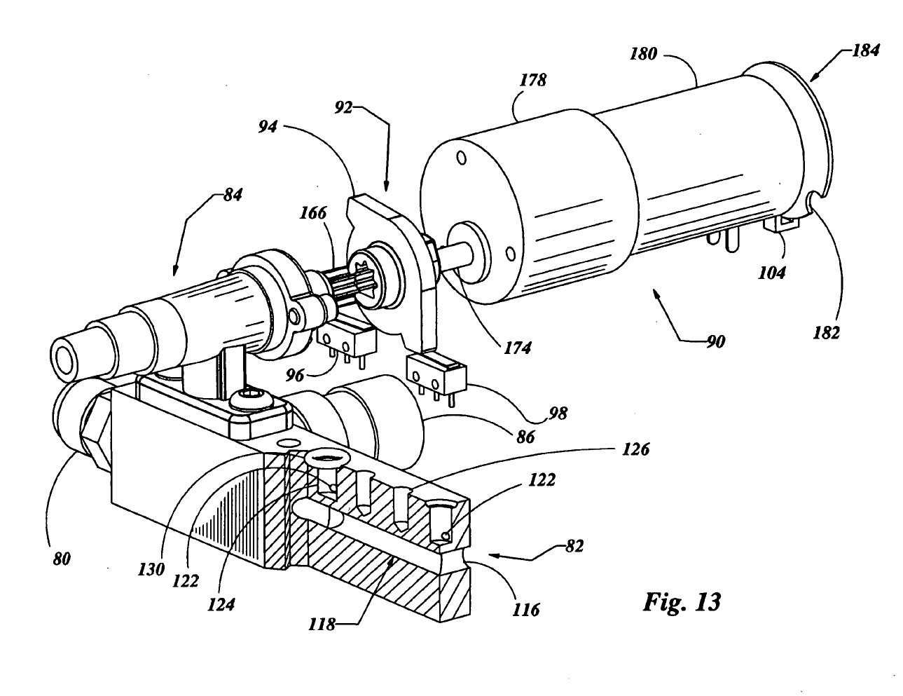

With reference to FIGS. 8-10, a first valve mount 117 is provided in this embodiment as a threaded hole in one side of the manifold 82 that passes through to a central core 118. An intake port 120 is threaded to accept the intake fitting 80 and seal from leaks. Though not critical, a national pipe thread (NPT) is the desired thread for such a connection. Gas will flow into the intake port 120 and to each of the first valve mounts 117. In a preferred embodiment the first valve 86 is a normally closed solenoid poppet valve, which mounts to one of the first valve mounts 117. When a first valve 86 is actuated, gas is allowed to flow through the valve 86 and into the valve exhaust chambers 122. The valve exhaust chambers 122 are continuous with a manifold exhaust port 124 adjacent to that valve exhaust chamber 122. A second valve 84 is mounted to the manifold 82 by the mounting holes 126, whereby the second valve intake port 128 (FIG. 11) of the second valve 84 aligns with one of the manifold exhaust ports 124 of the manifold 82. An “O-ring” 130 (FIGS. 12-13) is positioned between the base of the second valve 84 and the manifold 82 to ensure a substantially airtight seal.

With reference to FIG. 11, a displaced, partial sectioned view of a second valve 84 is shown. A body 132 includes a barrel 134 supporting a base 136 by way of a stem 138. A central cavity 140 within the body 132 includes the intake port 128 in the base 136 of the body 132. This central cavity 140 allows for free flow from the intake port 128 to the valve output port 142 if not for the flow restriction provided by a core 144. The core 144 is shown here to be displaced from the body 132 and with a section removed to better illustrate how it functions. The core 144 includes a longitudinal void 146 that is positioned collinear with the long axis 148 of the valve body 132. The tapered external surface of the core 144 mates with the internal wall of the central cavity 140. A cross bore 150 of the core 144 is in line with the intake port 128 of the body 132. In the position shown, the cross bore 150 and the intake port 128 are aligned, providing free flow through the valve 84. When the core 144 is rotated relative to the body 132, the resultant orifice of the cross bore 150 and the intake port 128 is reduced, thus flow is restricted.

A coil spring 152 provides a friction contact between the tapered surfaces of the core 144 and the central cavity 140, thereby maintaining a seal. A washer 154 may be used to limit the rotation of the core 144 by positioning the washer wing 156 between the two knockout tabs 158 of the bearing cap 160. A center section 162 of the input shaft 88 is received by a bearing portion 164 of the bearing cap 160 with a coupling end 166 extending through the cap 160. Fasteners 168 mount the cap 160 to a valve body face 170. The core 144 is articulated by the input shaft 88, in which a core receiver 172 mates with an input shaft 88. It is notable in this embodiment that the shape of the coupling end 166 of the input shaft 88 is irregular in shape. This is done to ensure only one way of assembly. As is seen, if the core 144 is rotated from the starting position, the flow will be incorrect throughout its operation. Though preferred, the irregular shape is not required.

With reference to FIGS. 12 and 13, another embodiment of position measurement of the actuator 90 and therefore the second valve 84 is shown. A preferred embodiment of the actuator 90′ is a DC electric motor with a gearbox 178 mounted to the motor 180, thus referred to as a gear-motor. The preferred gear-motor used is a high-speed motor, such as 4500-6000 r.p.m. (revolutions per minute), to reduce dust buildup on the brushes (not shown) when using a “brushed” DC motor. This is substantially less expensive than brushless motors, and are therefore preferable in this application. The torque output from the gearbox 178 should be sufficient to insure the friction of the valve can always be overcome by the motor 180. The gearbox output speed should be around 5 r.p.m. The gearbox 178 ratio can be at or near 1000:1 (motor revolutions to gearbox output shaft revolutions). Thus, a very accurate method of measuring the rotation of the gearbox output shaft 174 (FIG. 13) is to measure the movement of the motor shaft 176. Given that the front end of the motor shaft 176 is housed within the gearbox 178, the only position available is at the rear of the motor 180. In this case only a single notch 182 need be placed in a motor optical disk 184. If a 1000:1 gearbox 178 is used, there are two hundred and fifty pulses through the optical sensor 104 for a 90-degree rotation of the output shaft 174 and therefore the coupling 92. To get 25 pulses from the optical disk 100 mounted to the coupling 92 (as previously disclosed) requires a more expensive laser cut plate and the potential for one of the small slots to become blocked by dirt or other debris, is much more likely. Also with 10 times the number of pulses per unit of angular displacement, the resultant error of missing a pulse is 1/10^{th} as large. In either case, the disks (100 & 184) are substantially a non-concentric plate thereby offering some form of detection of a repeatable interrupt of a stationary optical sensor 104.

A power supply is used to drive all electrical components. The power supply can be from a battery of any numerous types, or from alternating current (AC) power from a wall plug. In the preferred embodiment, an AC cord is included to be received in a wall plug, but the system is run off one or more lead acid rechargeable batteries. The AC power can therefore function to recharge the battery or run the system if the battery power fails.

Other types and sensor arrangements can also be used. Some of those include capacitive and inductive proximity sensors. These also work in conjunction with an “interrupt” due to a passing material in close proximity to the sensor. Capacitive proximity sensors are in effect ½ of a capacitor in that it includes one capacitive plate as part of the sensor. The rotating disk (100 or 184), or any other structure intermittently passing in very close proximity to the capacitive plate creates a capacitance, or store of energy. This can signal a relay or other device to act and thereby determine a rotation or a partial rotation (depending on the shape) of the disk (100 or 184). For a capacitive sensor, a non-metal disk can be used. This is not the case for an inductive proximity sensor. Inductors store electric current in a magnetic field created by a coil of conductive wire with a current passing through it. When a metallic material is brought near the sensor, it acts as a “core” to the magnet, and greatly increases the inductance. This triggers the sensor's output. As before, a non-concentric (now ferrous metal) disk (100 or 184) rotating to repeatedly change the inductance one or more times per revolution enables movement of the disk (100 or 184) to be measured.

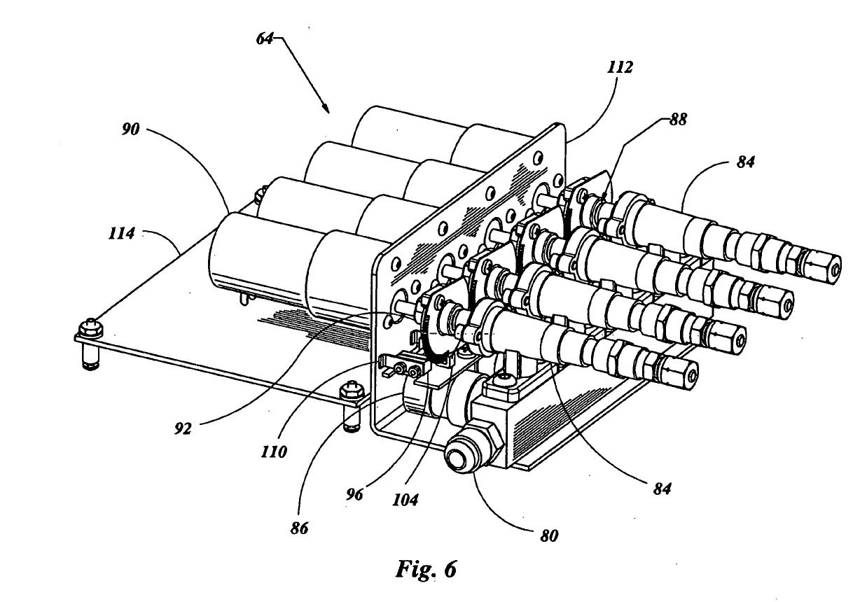

There are other sensors that use a magnetic field. One is a simple magnetic proximity sensor. These are typically “on-off” reed switches that are actuated by the permanent magnet (mounted to the disk (100 or 184)) that would pass intermittently near the reed switch. When the field strength is great enough, the reeds of the switch move to make contact and close the switch, allowing current flow. When the magnetic field is moved away from the reeds, they spring apart, opening the switch. By counting the “on-off” cycles, the number of rotations can be determined. In practical matters, the capacitive, inductive and magnetic switches would need to operate by the disk 184 mounted to the motor shaft 176 to allow greater physical displacement of the disk 184 relative to the sensor. The optical sensor system as disclosed in FIGS. 6 & 7 allows for both a displacement directly with the second valve 84 or indirectly through the motor shaft 176 as in FIG. 12.

Another system that could be adapted to work with minimum displacement or greater displacement is a Hall effect sensor. A Hall effect is a magnetic sensor, which utilizes a conductor or semiconductor plate that produces a voltage when exposed to a magnetic field. The voltage is directly proportional to the magnetic flux density of the field, therefore the distance from the magnetic source could be determined. In addition, the Hall effect differentiates between the positive and negative charges. Therefore the direction of the lines of flux can be determined.

With all sensors, except the magnetic proximity sensors, there are no mechanically moving parts. This enables millions of cycles without wear. The inductive and Hall effect sensors can function in dirty conditions and for the most part, the capacitive sensors as well. The optical sensors are preferably protected from debris, which would block the light sensor 104 and render the device inoperative. Given the box design in this invention, it is easy to seal the unit from dirt, insects and other debris. Therefore given the low expense, small size and a life expectancy of millions of cycles of an optical system, this is considered the preferred embodiment. As there are limitations to all reductions to practice, it is understood that all forms of position sensing currently available and available in the future are understood to be adaptable to a system that could be used in the disclosed invention.

With particular reference to FIG. 13, a portion of the manifold 82 has been removed to show how the O-ring 130 is seated in the top of the manifold exhaust port 124. The only method of fluid communication between the central core 118 and the manifold exhaust port 124 is through the first valve 86 (only one shown in this figure) and to the valve exhaust chambers 122 and finally into the manifold exhaust port 124.

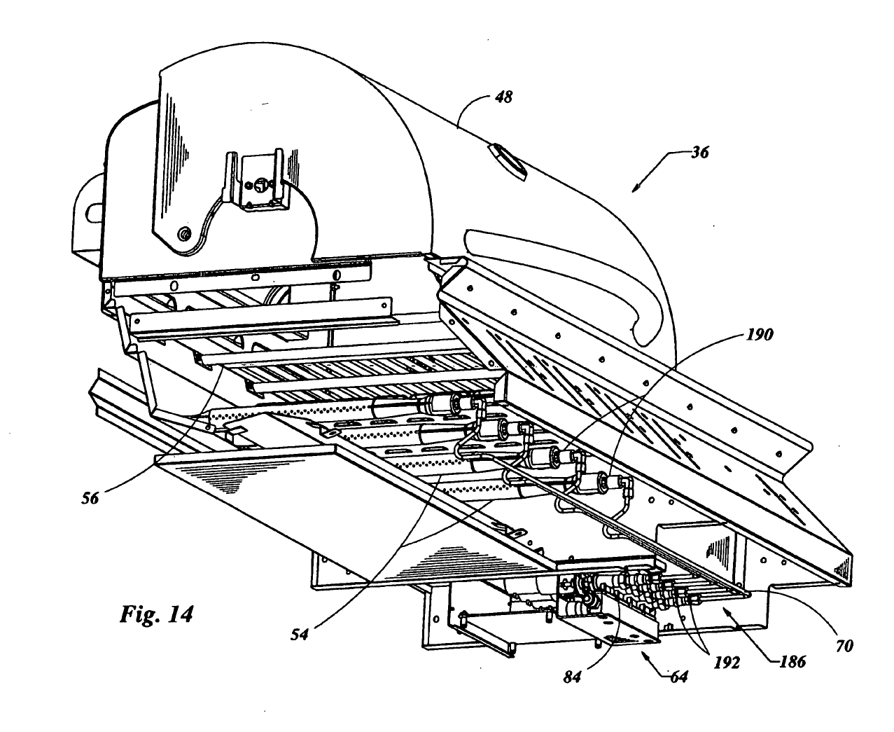

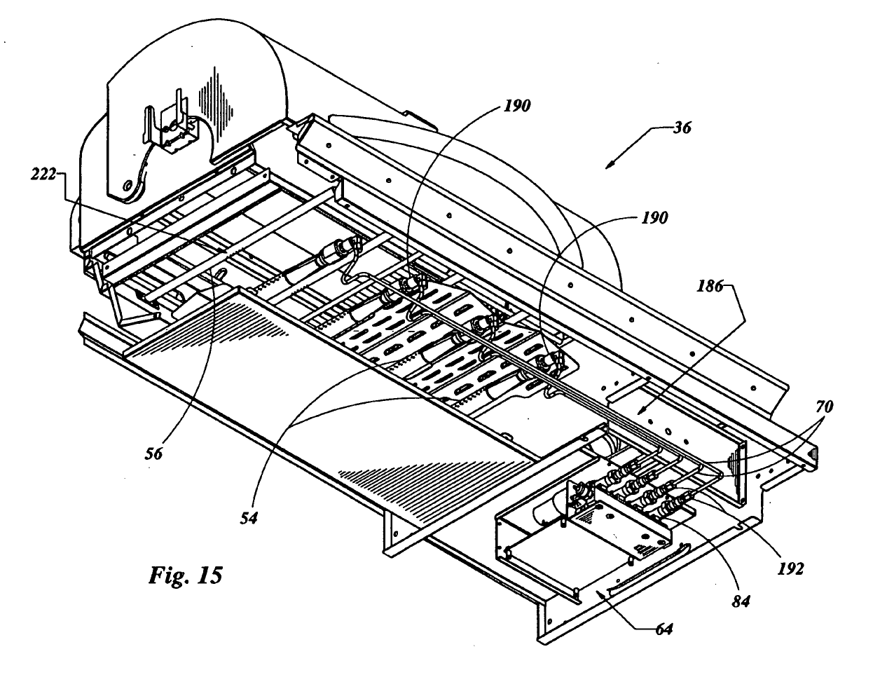

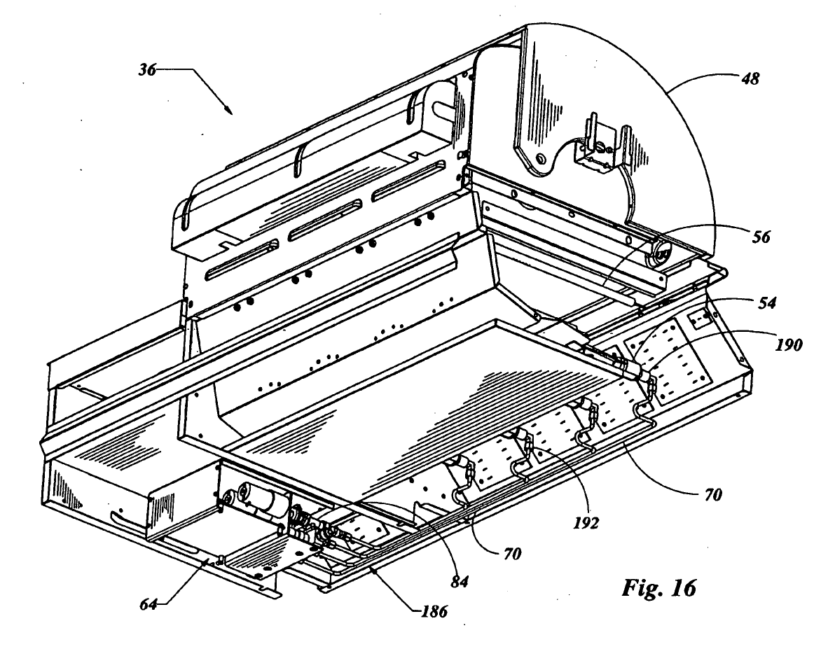

With reference to FIGS. 14-16, the control box 64 with the output 186 includes the tube 70 connecting each second valve 84 with a corresponding burner tip 190. The burner tips 190 are positioned adjacent to each burner 54. The tubes 70 can be made of any appropriate metal, such as aluminum, brass, steel or copper or any of a number of alloys. The tube size can vary according to desired heat output of the burners 54. It is desirable to use compression fittings 192 to secure the tube 70 because they can make airtight seals and be removed and refastened without damage or leakage. Here, the thermal control may or may not be incorporated. In these views the thermal control tubes 56 are positioned directly above each burner 54. The thermal control tubes 56 include a series of heat holes 222 in the bottom wall of the tube 56, located toward the center thereof. This is best illustrated in FIG. 15. These holes 222 act as vents to allow heat flow into and out of the tubes 56.

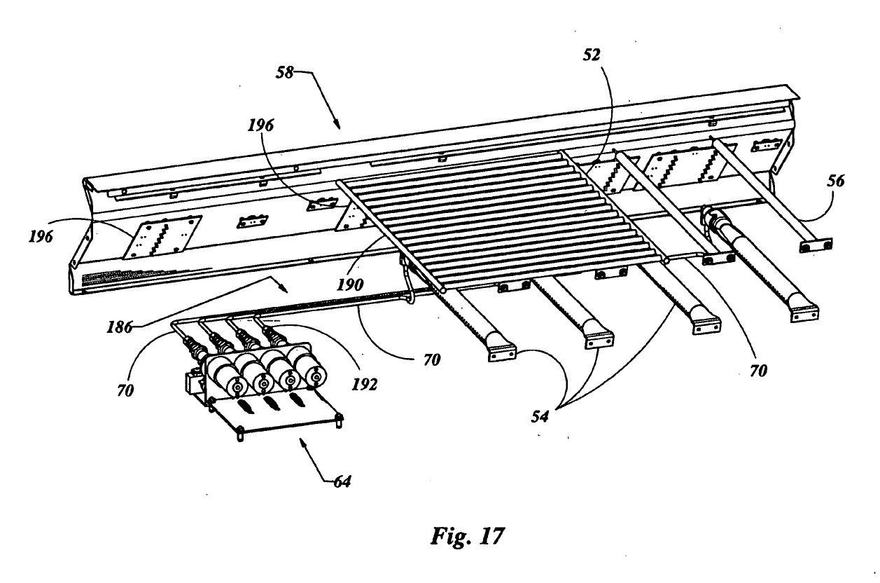

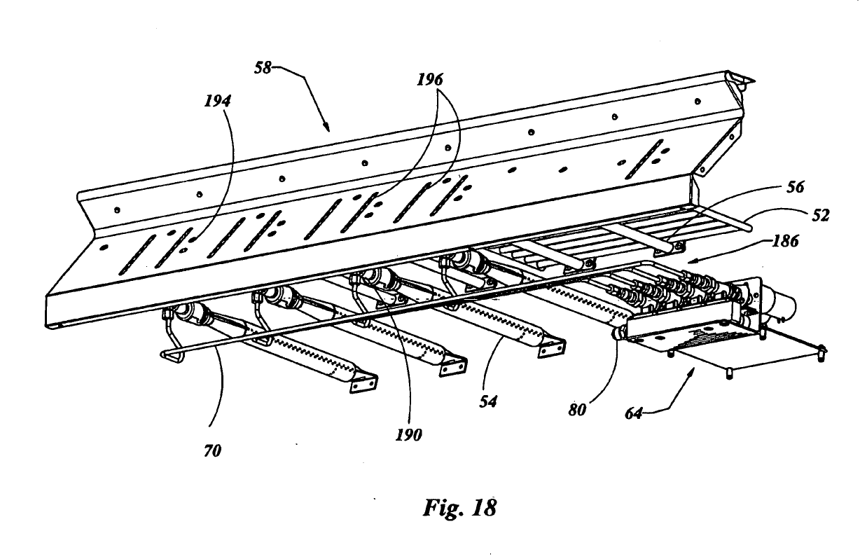

With reference to FIGS. 17 and 18, the control box 64 with its components as previously noted, functionally takes pressurized gas from a source, then selectively and variably controls the gas flow into the outputs 186 including the tubes 70 to the burner tips 190 and then to the burners 54. The thermal control tubes 56 sit above each burner 54 and each includes a thermal sensor 224, shown in FIG. 24. The thermal control tubes 56 are positioned just under the cooking grid 52. Again, only one cooking grid 52 is shown. The cooking surface (a.k.a. the cooking grids 52) would typically cover the entire area above the burners 54. Information from the thermal sensor 224 is sent back to a processor (not shown) in the control box 64 to regulate the gas output, and therefore the heat output of that burner 54. The user input to this system is provided by switches 194 as part of the display 58. In a preferred embodiment a series of display PC boards 196 are stuffed with light emitting diodes (LEDs) or some other lights 200. These can be arranged in any number of ways, and is shown here in one form according to rows with slots 198 cut into the face of the panel 58. In this embodiment of the invention, the lights 200 give a feedback to the user regarding the set temperature (T_{S}) and the current temperature (T_{C}). The switches 194 in the form of buttons, allow for user input and turning the appliance on and off.

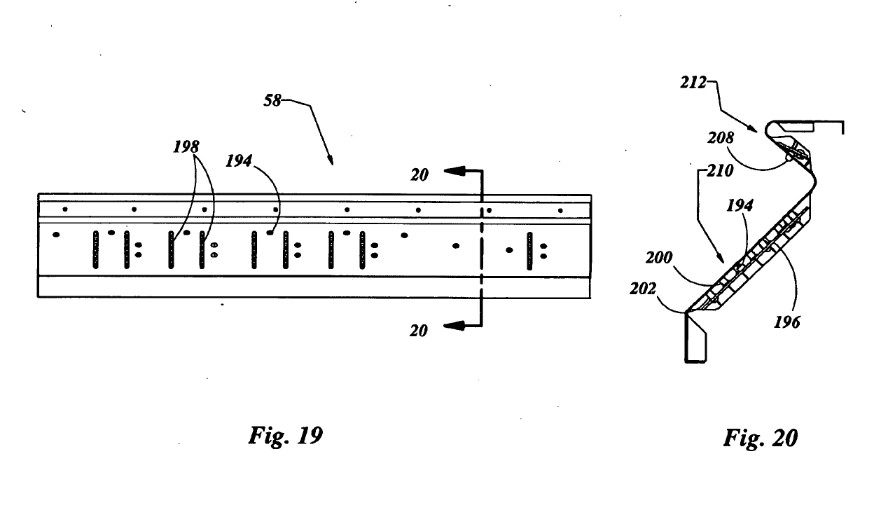

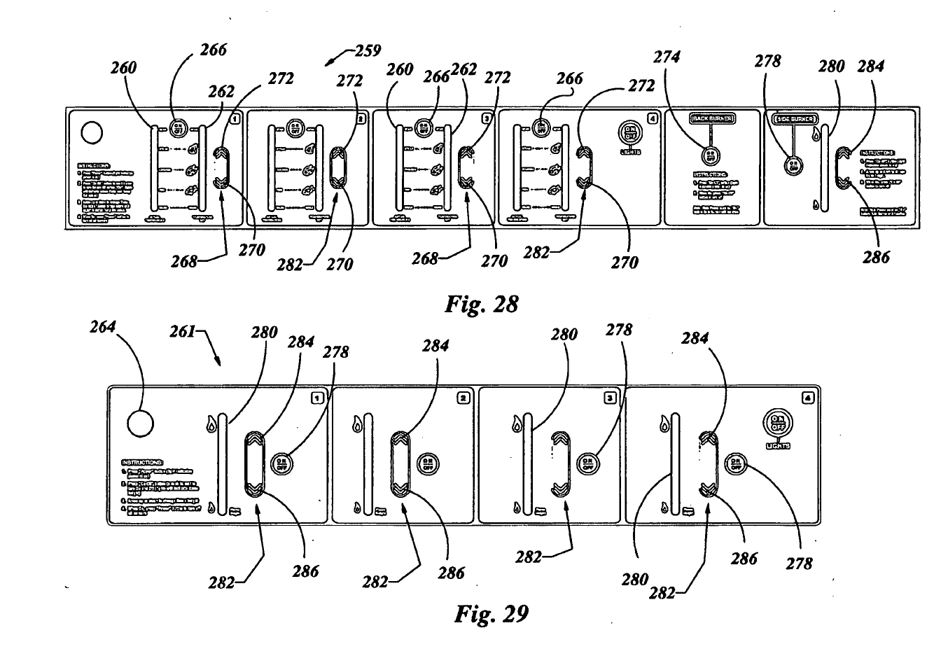

With reference to FIGS. 19-21, a series of lights 200 are positioned on the display PC boards 196. The lights 200 are preferably red LEDs. The switches 194 are preferably pressure switches that are mounted to the display PC board 196. The display PC boards 196 are mounted to the inside of the frame of the display 58 by a series of standoffs 202. These allow space between the display PC board 196 and the frame of the display 58 and also allow the boards 196 to be adjusted for position relative to the frame of the display 58. This allows the switches 194 to be properly positioned so they can be actuated by the user and not inadvertently actuated by the pressure of an overlay 259 and 261 as shown in FIGS. 28 and 29. The overlay 259 seals the environment out and gives instruction and design appeal to the product.

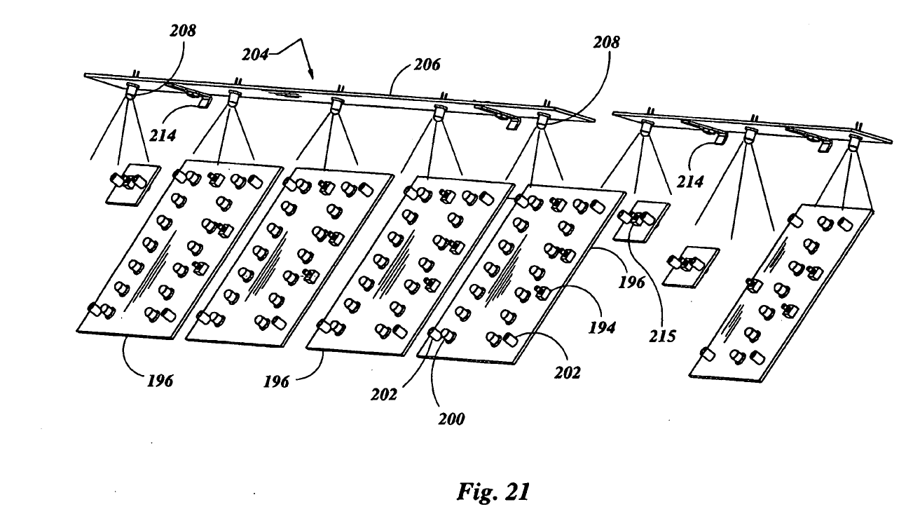

With particular reference now to FIG. 21, another form of lighted PC board 206 is shown to include a display light 204. The display light 204 includes a light PC board 206 which secure at least one light LED 208. The light LEDs 208 are preferably white LEDs. The white LEDs are made to dispense light to the display panel 210 and are typically housed within a “bull-nose” 212 or protrusion at the upper portion of the display 58. One or more light brackets 214 can support the light PC boards 206. These light LEDs 208 are connected to a power source (not shown) and a switch 215 to selectively turn the lights on and off. The display light feature is an addition to the basic functional invention as disclosed herein.

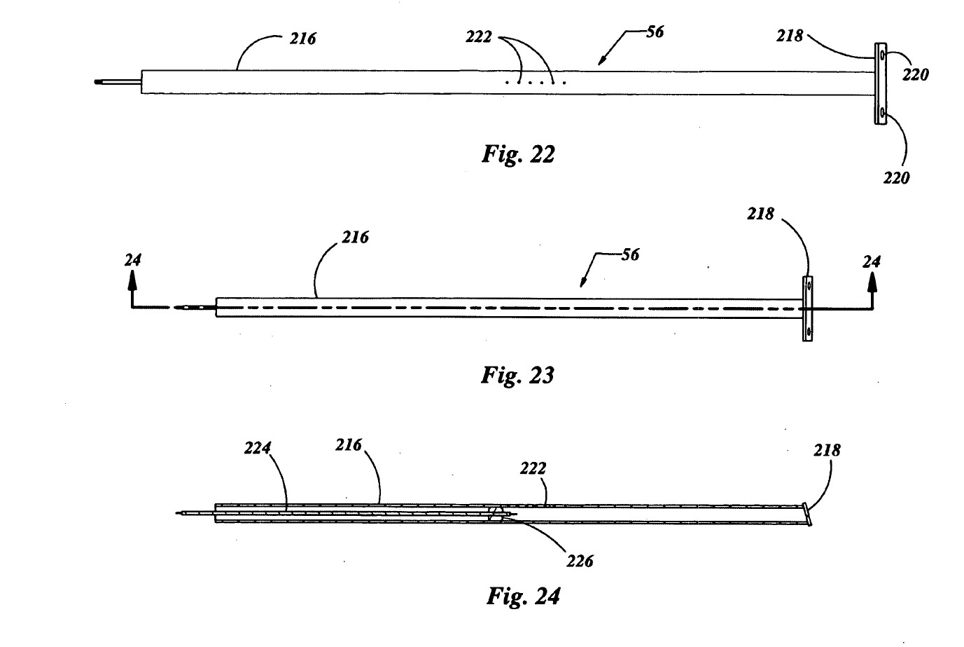

With reference to FIGS. 22-24, a thermal control tube 56 includes a tube structure 216 with a mounting bracket 218 on one end. This bracket 218 can be a separate plate, as illustrated here, or it can be a deformation of the tube structure 216 to create a flattened end suitable for mounting. A pair of holes 220 is positioned in the bracket 218 to allow for mounting to the back of the firebox 50 of the appliance 32. A set of small heat holes 222 are placed in the tube structure 216 to allow for rapid heat transfer between the outside and inside of the structure 216. One hole will function but a plurality is preferred. The holes 222 are small enough that insects and spiders cannot enter but large enough that air will freely transfer without being clogged by dust. The holes 222 are preferably positioned in the bottom of the tube structure 216 so as to avoid contamination from the cooking food positioned on top of the tube structure 216.

With particular reference to FIG. 24, the internal structure of the thermal control tube 56 is shown. The tube structure 216 is used to protect the thermocouple wire 224 housed therein. A traditional thermocouple probe can also be used as the thermal control tube 56, but due to cost efficiency, this embodiment is preferred. In essence, the structure as shown and described here is functionally equivalent to a thermocouple probe, only the thermocouple probe is usually a sealed tube with the thermal sensitive wire encased therein. The probe is a complete purchased item and is very durable and already assembled. The cost is traditionally greater. As to the function of the disclosed invention, both would function equally well and the choice is considered a design decision, in that both provide a housing that protects a thermocouple wire located inside.

In this embodiment, the thermocouple wire 224 is a bare wire bead thermocouple, which includes two dissimilar metal wires that are welded together at one end as a bead. Applying heat to the junction generates a voltage between the leads that is substantially linearly related to the temperature. Another type of temperature sensor is a resistance temperature detector (RTD), which is a conductive wire that changes resistance relative to the temperature applied. A current must be applied to the RTD in order for the resistance to be measured. A thermocouple will typically handle much higher temperatures and are easier to use because no applied current is necessary. With a thermocouple, the voltage output is generated relative to the temperature in the environment. The preferred embodiment is a nickel-chromium/nickel-aluminum or type K thermocouple, though it is understood that any type of thermocouple, thermocouple probe or RTD could be used in the proper temperature and environmental conditions. As such, the disclosure relating to the type K bare wire bead thermocouple is not intended to be limiting. An infrared temperature sensor can also be used, but due to the presence of food on the cooking surface and changes in color and texture of the cooking surface over time and with use, the infrared is less desirable than a thermocouple.

The bare wire is preferably wrapped in insulation, usually fiberglass, to withstand the extreme heat. The bare wire end of the thermocouple 224 must not contact any metal or the voltage would be altered. To solve that issue, a support plug 226 is pressed into the core of the tube structure 216 just free of the bare wire end of the thermocouple 224. The constructed material is preferably a thermal insulator and with a round tube structure 216, the support plug 226 would be a cylindrical block with a center hole to receive the thermocouple wire 224. The insulated wire of the thermocouple 224 extends out the free end of the tube structure 216 toward the display 58 of the appliance 32. The plug 226 not only supports the bare wire end of the thermocouple 224, but it is positioned on the display side of the heat holes 222. This helps prevent the heat near the thermocouple end from escaping through the open end of the tube 216, thereby keeping the temperature readings accurate with the actual temperature in the firebox 50 near the cooking surface of the appliance 32.

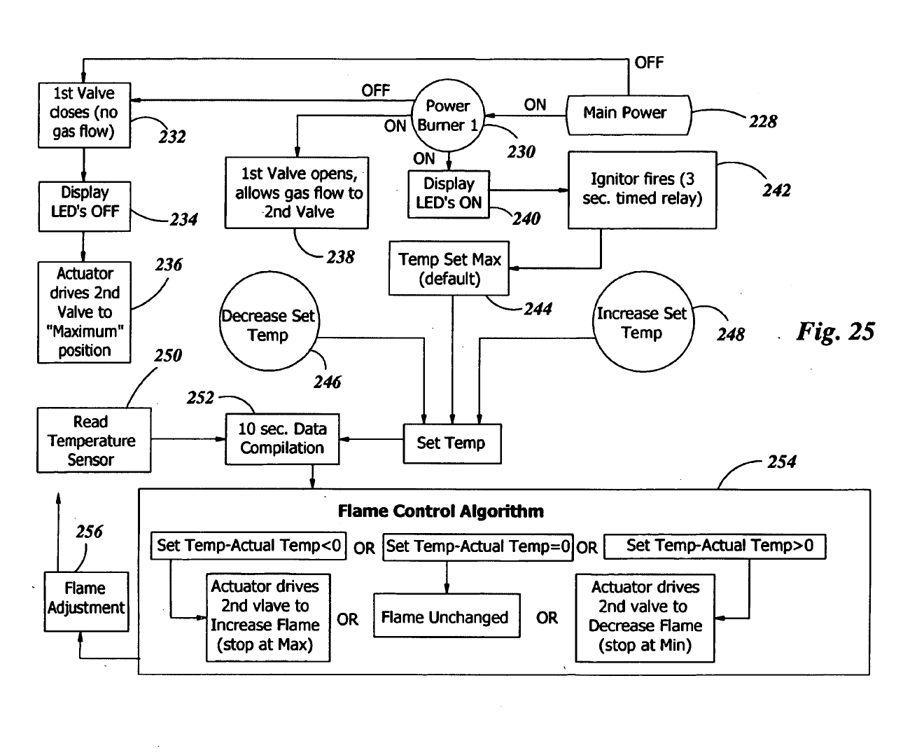

With reference to FIG. 25, the logic process of the control system is illustrated in a flow chart. For safety, it is desired that a two-stage safety switch be used. In this embodiment, the main power 228 switch must be turned “on” before any burners 54 can be turned on by their individual switches 230. When the main power is turned off, the control system activates a short “shut down” process. This includes closing all first valves 232, turning off all display lights 234 and driving all actuators to open all second valves to maximum flow position 236. This prepares the second valves for start-up when the next start sequence is initiated.

With the main power 228 turned “on,” one or all of the individual burners 54 can be turned on by actuating the switch for each specific burner. The flow chart illustrates the process for one burner only, but the process is preferably the same for any additional burners 54 within the thermal controlled system. When an individual burner is turned off, the shutdown sequence is followed as noted above, but only for that burner.

Using the control system, any burner is turned on by actuating the switch 230 for that burner when the main power 228 is also “on.” This opens 238 the first valve to allow gas flow to the second valve for that burner, activates 240 the display lights, and through a timed relay, causes the igniter to fire for 3 seconds 242. For the thermal control using the control system, the set temperature 244 defaults to maximum or a “sear” temperature as read by the thermal sensor above that burner. The user can then decrease 246 the set temperature and after it is decreased from maximum, the user can further decrease or increase 248 the set temperature. At a time period, such as every ten seconds, the control system will evaluate the current set temperature. At a sample rate of 10 Hz or more, the control system will read 250 the thermal sensor above that burner and store the temperature data (t₁, t₂, . . . tₙ). The mean (tₐᵥₑ) temperature is determined from that data according to the formula:

tₐᵥₑ=(t₁+t₂+ . . . tₙ)/n

The mean temperature (tₐᵥₑ) is compiled into a register and evaluated versus time. This generates a curve for the function ƒ(t) and is recalculated every time a new tₐᵥₑ is added to the register. A maximum time period, such as 60 seconds, of the most recent data is maintained in the register at any time. The function ƒ(t) is evaluated 252 to determine the rate of change, value and direction of change. This is determined by the current tₐᵥₑ value and the slope of the curve at that time or first derivative (D) of the function ƒ(t):

D=ƒ(t)dt

### This information is processed by a flame control algorithm 254 to determine a flame adjustment 256. This adjustment can be zero (no change), go to maximum flame, go to minimum flame or anything in between.

It is important to note that the function of this control system is very different from a thermostat of a room or even an oven. These are “on-off” systems that regulate temperature within a range in a predominately closed environment. An oven door is seldom opened during the baking process, so the heat stays in the oven. Also, the door is usually on the side and not the top where maximum heat will escape when opened. The oven is usually indoors and therefore not subjected to wind and extreme temperature conditions. Finally the temperature of an oven seldom gets above 400° F. This is in contrast to the cooking surface temperature of an exposed cooking grate in a grill appliance, which can be at or near 1000° F. With any of these conditions, let alone the possibility of all of them at once, the heat loss due to opening the lid, or a gust of wind can be dramatic to the temperature near the exposed cooking grid. Proper grilling requires the proper temperatures to be maintained. Therefore, rapid adjustment and control of the heat at the area of the food is very important.

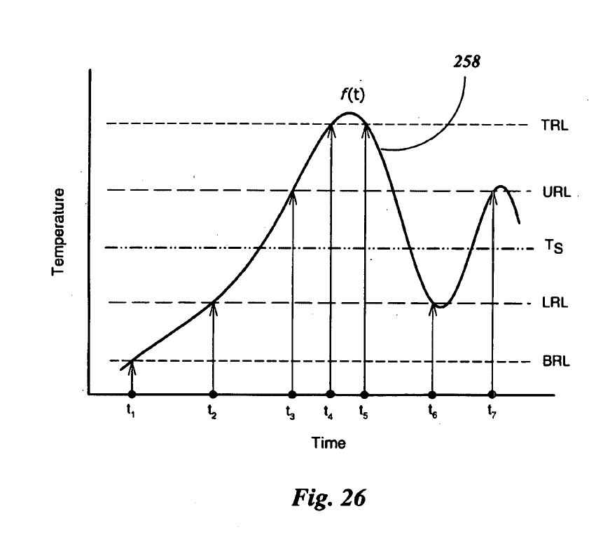

A process used to control the flame is illustrated by the graph in FIG. 26. The function ƒ(t) 258 is presented over time. The center line (T_{S}) is representative of the Set Temperature. This is the desired temperature of the cooking surface as determined by the user. The dashed line directly above the Set Temperature is the Upper Range Limit (URL) and that below is the Lower Range Limit (LRL). These range limits represent the acceptable range above and below the Set Temperature in which the control system will not alter the gas flow and therefore the heat output of the burner (between t₂ and t₃). The upper line is representative of the Top Range Limit (TRL) and the lower is the Bottom Range Limit (BRL). When the current temperature (tₐᵥₑ) is above the TRL (between t₄ and t₅) the gas flow will go to minimum to reduce the heat as quickly as possible while still maintaining a flame. Likewise, when the current temperature (tₐᵥₑ) is below the BRL (to the left of t₁), the gas flow set by the second valve will be maximum to increase the temperature as quickly as possible.

When the current temperature (tₐᵥₑ) is greater than the URL and less than the TRL (between t₃ and t₄) or greater than the BRL and less than the LRL (between t₁ and t₂) the flame control algorithm determines if and how much the second valve should be adjusted. With this, the actual value of tₐᵥₑ is evaluated as to the distance from the range limits. Also, the derivative (D) of the function is evaluated (ƒ(t)dt) to determine the direction and rate of change of the current temperature (tₐᵥₑ). From this, the algorithm provides an adjustment to bring the current temperature to the set temperature as quickly as possible and maintain it there with as few adjustments as possible. Every time the actuator adjusts the second valve, the system will wear. Optimizing the flame control process is minimizing the number of adjustments while maintaining the temperature within the acceptable upper and lower range limits (URL & LRL respectively).

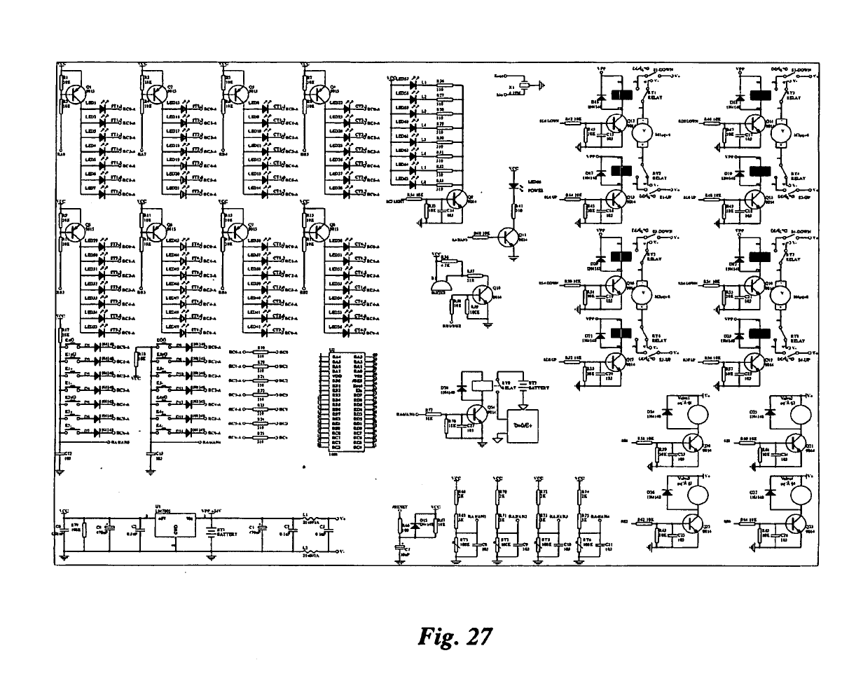

An electrical schematic of the thermal controlled process using the control system is shown in FIG. 27. A series of LEDs are used to represent feedback as to the current temperature (tₐᵥₑ) and the set temperature (T_{S}). This is laid out on the left half of the schematic. On the right are actuators (as DC electric gear motors), which control the second valves to the main burners. The lower right section is the control for the first valves that are electrically controlled, normally-closed solenoid valves, which function to selectively allow gas flow from the source to the second valves. A main power circuit and a buzzer (to provide a auditory stimulus to the user when a switch is actuated) are also shown.

With reference to FIGS. 28 and 29, displays 259 and 261 for two embodiments of the invention are shown. The embodiment shown in FIG. 28 utilizes the thermal control system overlay 259. The two sets of parallel vertical blanks include a clear window 260 for the vertical LEDs of the current temperature (tₐᵥₑ) on the left and a right clear window 262 for the set temperature (T_{S}) on the right in each cooking zone section. Each cooking zone section represents a main burner in this embodiment. The main power switch 264 is on the upper left and the burner switch 266 to turn on and off each burner independently from the others is positioned between the vertical windows 260 & 262. The set temperature switches 268 are located adjacent to the set temperature window 262. As a lower set temperature switch 270 is pressed, the lit vertical column of LEDs in the window 262 decreases to correspond with a lower T_{S} value to the thermal control system. The reverse is true when the upper set temperature switch 272 is pressed. The lit vertical column of LEDs moves up corresponding to a greater T_{S} value input to the thermal control system.

On the right portion of the overlay 259, a back burner switch 274 is displayed. A back burner is also known as a rotisserie burner. The control is a single “on-off” first valve that allows gas to flow to this burner. There is traditionally no temperature regulation of this burner, but it could be incorporated into the thermal control process as described on the main burners 54.

On the far right is a side burner section 276 Here the gas flow is initiated by the side burner switch 278, which opens gas flow from a first valve as previously noted. The single vertical window 280 allows a vertical column of LEDs to show through. The vertical column of LEDs is representative of the flow position of the second valve as described herein. Instead of the thermal control adjusting the gas flow and therefore the temperature in relation to the set temperature and current temperature, there is no thermal control system on the side burner. Instead the actuator to the second valve is controlled by the user to direct the flame adjustment. The upper switch 284 drives the actuator to increase gas flow through the second valve and the lower switch 286 drives the actuator to decrease gas flow through the second valve. This process is identical to that of a full cooking appliance with manual control.

With particular reference now to FIG. 29, the manual overlay 261 for a manual control embodiment is shown. The vertical window 280 allows sight of a vertical column of LEDs. The column of LEDs represents of a relative gas flow position of the second valve. The actuator to the second valve is controlled directly by the flame adjustment 282 switches. The upper switch 284 drives the actuator to increase gas flow through the second valve and the lower switch 286 drives the actuator to decrease gas flow through the second valve, thereby changing the flame height accordingly.

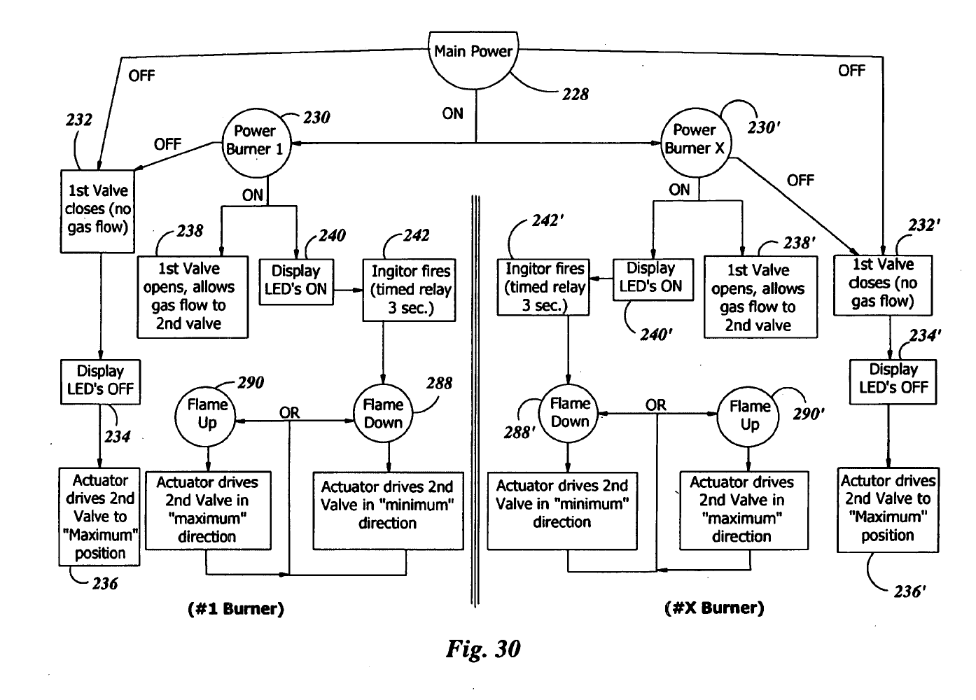

With reference to FIG. 30, a schematic of the manually controlled flame is presented. A two-burner version is illustrated with the second burner marked as burner “X.” This is done to clarify that any number of burners 54 could be used. As previously noted, the first portion of the flow chart, as per the functional process of both versions of the invention as disclosed, are identical. Therefore the same reference numbers are used according to FIG. 25. The identical aspects of the process of Buner #X in FIG. 30 are labeled with a (′) to show that they are mirrored from the process of Burner #1.

As before, a two-stage safety switch is used. For that, a main power 228 switch preferably must be turned “on” before any burners 54 can be turned on by their individual switches 230. When the main power is turned off, a short “shut down” process is activated. This includes closing all first valves 232, turning off all display lights 234 and driving all actuators to open all second valves to maximum flow position 236. This prepares the second valves for start-up when the next start sequence is initiated. With the main power turned “on,” the individual burners 54 are turned on by actuating the switch 230 for that burner. This opens 238 the first valve to allow gas flow to the second valve for that burner, activates 240 the display lights and 242 through a timed relay, causes the igniter to fire for 3 seconds. At this point, the burner has flame and is set at maximum flame. This is nearly always where the user would first position the burners 54, and the higher gas flow better enables the startup when igniting the initial flame.

To adjust the flame, the user need only actuate a flame down 288 switch. This drives the actuator, typically by closing an electrical circuit to an electric gear motor, to drive the second valve in toward the minimum flow direction. It is understood that a touch of the switch moves the second valve in that direction, not necessarily all the way to minimum. This reduces the gas flow to the burner and thereby reduces the flame. The flame is now less than maximum, and the user can adjust it up if desired by a flame up 290 switch. As the reverse of the flame down 288, the up 290 switch drives the actuator to move the second valve in the direction of maximum gas flow. As with the flame down process, the extent of the increase in gas flow is dependent upon the amount of time the user actuates the flame up switch and the number of times it is actuated. The maximum and minimum values are reached when the appropriate limit switches in the control box are contacted.

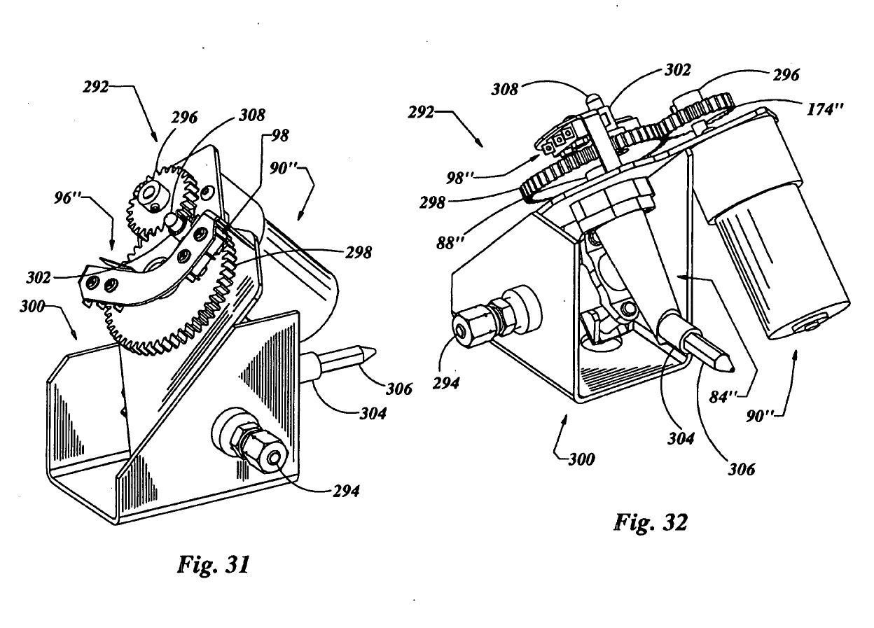

With reference now to FIGS. 31 and 32, a modular gas flow regulation system is shown. As a low cost alternative regulation assembly 292 that can be actuated completely electrically. A first valve (not shown) is located remotely from this unit and preferably includes a manifold similar to that as previously disclosed. Instead, a second valve 84 is mounted directly to a manifold 82 (as shown in FIG. 8) and a gas line 70 (as shown in FIG. 15) would run from each manifold exhaust port 124 (as shown in FIG. 8) to an intake port 294 of a regulation assembly 292. The actuator 90″ is again preferably a gear motor, only now with a first gear 296 mounted to the gearbox output shaft 174″. The first gear 296 drives a second gear 298, which is mounted to the valve input shaft 88″. A minimum limit switch 96″ and a maximum limit switch 98″ are both mounted to the frame 300 and are actuated by an LED support 302 that is mounted to the second gear 298, that is driven with the gear 298 between these two limits. A core (not shown) of the valve 84″ rotates with the gear 298 to regulate the gas flow from the intake port 294 through the stem 304 and finally out the burner tip 306 into a burner (not shown).

To give feedback to the user as to the position of the second valve 84″ and therefore the gas flow and flame height, an indicator LED 308 is received in the LED support 302, which is mounted to the second gear 298. The gear 298, and valve core, only rotate approximately 90 degrees, so a simple wire attachment to the LED 308 is adequate. Each of these assemblies 292 is mounted behind a display (not shown) and in front of a burner. A window is provided in the display for the user to view the relative position of the indicator LED 308. In this embodiment of the invention, no optical disk or optical sensors are needed in that the relative flame height is referenced to the indicator LED 308 position, which is viewed by the user.

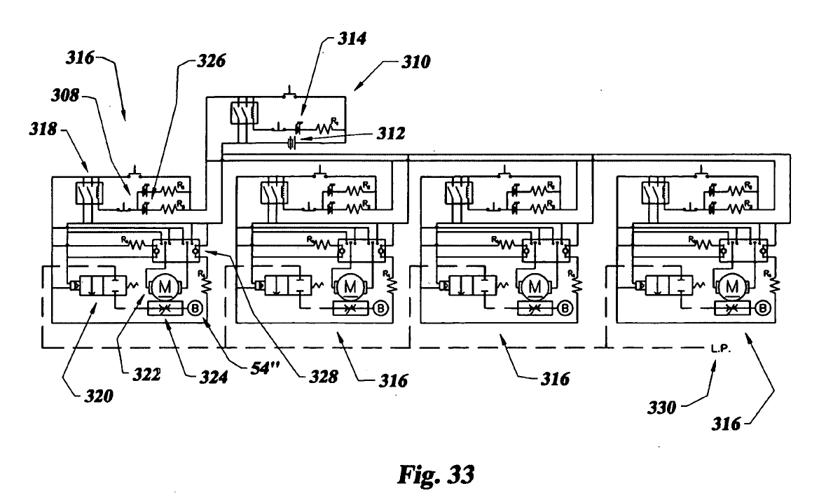

With reference to FIG. 33, the electrical schematic for this embodiment of the invention is shown. Latching switches (not shown) can be used in place of relays 318, one normally-open (N.O.) and one normally-closed (N.C.) switch, but functionally it is the same. A main switch 310 provides power from a battery 312 to each of the parallel systems below the main switch 310. An LED 314 shows the user that the power is on. The parallel burner systems 316 include a similar latching relay switch system 318 to feed each individual burner system 316. A two-way solenoid valve 320 is the first valve and the DC motor 322 actuates the variable second valve 324. This second valve 324 exhausts to the burner 54″. The indicator LED 308 gives the position of the burner and the second LED provides an indication as to what burner is on. The toggle switch 328 drives the motor 322 in one direction of the other to increase or decrease the flow of gas through the variable second valve 324 to the burner 54″. The solenoid valve 320 (first valve) controls the flow of gas (dashed line) from the source 330 to the variable second valve 324. What is noted here is “LP” for liquid propane as the fuel source 330. It is understood, however, that any combustible fluid can be used, including natural gas (NG).

The foregoing detailed description of the present invention is provided for purposes of illustration, and it is not intended to be exhaustive or to limit the invention to the particular embodiment shown. The embodiments may provide different capabilities and benefits, depending on the configuration used to implement key features of the invention.

What is claimed is:

1. A gas cooking appliance for connection to a source of gas, comprising:
a burner;
a cooking surface disposed adjacent to the burner;
a frame adapted to support the burner and the cooking surface; and
a first valve in communication with a second valve, wherein the first valve selectively enables a flow of gas from the source to the second valve, and wherein the second valve is adapted to provide a variably controlled output to the burner.

2. The gas cooking appliance according to claim 1, wherein the cooking surface is a cooking grid.

3. The gas cooking appliance according to claim 1, wherein the first valve is a two-way valve.

4. The gas cooking appliance according to claim 3, wherein the two-way valve is a normally closed valve.

5. The gas cooking appliance according to claim 3, wherein the two-way valve is a solenoid valve.

6. The gas cooking appliance according to claim 1, wherein the first valve selectively enables a flow of gas by way of at least one switch disposed on a front panel of the appliance, wherein the switch is electrically connected to the first valve.

7. The gas cooking appliance according to claim 1, wherein the second valve includes a core that is received by a body, wherein the relative position between the core and body determines flow of gas through the second valve.

8. The gas cooking appliance according to claim 7, further comprising an actuator in communication with the core of the second valve and adapted to displace the core, whereby movement of the core alters gas flow through the second valve.

9. The gas cooking appliance according to claim 1, further comprising an actuator in communication with the second valve and adapted to variably control gas flow to the burner.

10. The gas cooking appliance according to claim 9, further comprising at least one switch disposed on a front panel of the appliance, the switch electrically connected to the actuator.

11. The gas cooking appliance according to claim 9, wherein the actuator includes an electric motor.

12. The gas cooking appliance according to claim 1, wherein the output to the burner includes a stem with a burner tip mounted to a distal end of the stem.

13. The gas cooking appliance according to claim 1, wherein the output to the burner includes a tube connecting the second valve to a burner tip adjacent to the burner.

14. The gas cooking appliance according to claim 1, further comprising an ignition system adapted to ignite the gas adjacent to the burner.

15. The gas cooking appliance according to claim 1, further comprising a position feedback system including a disk in mechanical communication with the second valve and a sensor adapted to provide feedback from incremental movement of the disk.

16. The gas cooking appliance according to claim 15, wherein the disk is non-concentric.

17. The gas cooking appliance according to claim 15, wherein the sensor is a device selected from the group consisting of a optical sensor, a Hall effect sensor, an inductive proximity sensor, capacitive proximity sensor, and a magnetic proximity sensor.

18. The gas cooking appliance according to claim 1, further including, a thermal control comprising:
a thermal sensor mounted adjacent to the cooking surface;
a switch adapted to input a set temperature value;
an actuator in communication with the second valve; and
a control system adapted to drive the actuator relative to output from the thermal sensor and the set temperature value.

19. The gas cooking appliance according to claim 18, wherein the thermal sensor is a sensor selected from the group consisting of a bare wire bead thermocouple, a thermocouple probe and an infrared temperature sensor.

20. The gas cooking appliance according to claim 18, wherein the thermal sensor includes a Nickel-Chromium/Nickel-Aluminum (Type K) bare wire bead thermocouple housed in a tube.

21. The gas cooking appliance according to claim 20, further including a support plug housed within the tube and supporting a free end of the wire bead thermocouple.

22. The gas cooking appliance according to claim 21, wherein the support plug includes a block with a center bore to receive the wire bead thermocouple.

23. The gas cooking appliance according to claim 22, wherein the tube is a stainless steel tube with a plurality of holes in one wall of the tube.

24. The gas cooking appliance according to claim 23, wherein the holes are positioned substantially in a middle portion of a length of the tube.

25. The gas cooking appliance according to claim 18, wherein the thermal sensor includes a thermocouple probe.

26. The gas cooking appliance according to claim 25, wherein the thermocouple probe is housed in a cover mounted to the frame.

27. The gas cooking appliance according to claim 18, wherein the thermal sensor includes a resistance temperature detector (RTD).

28. The gas cooking appliance according to claim 18, wherein the control system includes a processor adapted to monitor Current Temperature (T_{C}) data from the thermal sensor and compare to the Set Temperature (T_{S}), the control system providing a control output to the actuator based on temperature history and Current Temperature (T_{C}).

29. The gas cooking appliance according to claim 28, wherein the control output is Maximum Flame (F_{MAX}) when the Current Temperature (T_{C}) is less than a Bottom Range Limit (BRL) and the output is Minimum Flame (F_{MIN}) when the Current Temperature (T_{C}) is greater than a Top Range Limit (TRL).

30. The gas cooking appliance according to claim 28, wherein the control output is unchanged when the Current Temperature (T_{C}) is between a Lower Range Limit (LRL) and an Upper Range Limit (URL).

31. The gas cooking appliance according to claim 28, wherein the control output is derived from a control algorithm when the Current Temperature (T_{S}) is between a Bottom Range Limit (BRL) and a Lower Range Limit (LRL) or between a Top Range Limit (TRL) and an Upper Range Limit (URL).

32. The gas cooking appliance according to claim 31, wherein the control algorithm includes the first derivative of the function of previous Current Temperature (T_{C}) values, the Current Temperature (T_{C}) value and the difference between the Current Temperature (T_{C}) value and the Set Temperature (T_{S}) value.

33. The gas cooking appliance according to claim 1, further comprising a light that is adapted to illuminate a front panel of the appliance.

34. A cooking system for connection to a source of gas, comprising:
a frame supporting a cooking surface and at least one burner;
a first valve in fluid communication with the at least one burner by way of a variably controlled second valve; and
a switch in communication with the first valve, whereby actuation of the switch enables gas flow from the source to the at least one burner.

35. The gas cooking appliance according to claim 34, wherein the first valve is a two-way valve.

36. The gas cooking appliance according to claim 35, wherein the two-way valve is a normally closed valve.

37. The gas cooking appliance according to claim 35, wherein the two-way valve is a solenoid valve.

38. The gas cooking appliance according to claim 34, wherein the variably controlled second valve includes a core that is received by a body, the relative position between same determines flow.

39. The gas cooking appliance according to claim 38, further comprising an actuator in communication with the core of the variably controlled second valve and adapted to displace the core, whereby movement of the core alters gas flow.

40. The gas cooking appliance according to claim 34, further comprising an actuator in communication with the variably controlled second valve, whereby the actuator alters the second valve to vary gas flow to the at least one burner.

41. The gas cooking appliance according to claim 40, further comprising at least one switch disposed on a front panel of the appliance, the switch electrically connected to the actuator.

42. The gas cooking appliance according to claim 40, wherein the actuator includes an electric motor.

43. The gas cooking appliance according to claim 34, further comprising an ignition system adapted to ignite the gas adjacent to the burner.

44. The gas cooking appliance according to claim 34, further comprising a position feedback system including a disk in mechanical communication with the variably controlled second valve and a sensor adapted to provide feedback from incremental movement of the disk.

45. The gas cooking appliance according to claim 44, wherein the disk is non-concentric.

46. The gas cooking appliance according to claim 44, wherein the sensor is a device selected from the group consisting of a optical sensor, a Hall effect sensor, an inductive proximity sensor, capacitive proximity sensor, and a magnetic proximity sensor.

47. The gas cooking appliance according to claim 34, further comprising, a thermal control including:
a thermal sensor mounted adjacent to the cooking surface;
an input device adapted to input a set temperature value;
an actuator in communication with the variably controlled second valve; and
a control system adapted to drive the actuator relative to output from the thermal sensor and the set temperature value.

48. The gas cooking appliance according to claim 47, wherein the thermal sensor is a sensor selected from the group consisting of a bare wire bead thermocouple, a thermocouple probe and an infrared temperature sensor.

49. The gas cooking appliance according to claim 47, wherein the thermal sensor includes a Nickel-Chromium/Nickel-Aluminum (Type K) bare wire bead thermocouple housed in a tube.

50. The gas cooking appliance according to claim 49, further comprising a support plug housed within the tube and supporting a free end of the wire bead thermocouple.

51. The gas cooking appliance according to claim 50, wherein the support plug includes a block with a center bore to receive the wire bead thermocouple.

52. The gas cooking appliance according to claim 49, wherein the tube is a stainless steel tube with a plurality of holes in one wall of the tube.

53. The gas cooking appliance according to claim 52, wherein the holes are positioned substantially in a middle portion of a length of the tube.

54. The gas cooking appliance according to claim 47, wherein the thermal sensor includes a thermocouple probe.

55. The gas cooking appliance according to claim 47, wherein the thermal sensor includes a resistance temperature detector (RTD).

56. The gas cooking appliance according to claim 47, wherein the control system includes a processor adapted to monitor Current Temperature (T_{C}) data from the thermal sensor and compare to the Set Temperature (T_{S}), the control system providing a control output to the actuator based on temperature history and Current Temperature (T_{C}).

57. The gas cooking appliance according to claim 56, wherein the control output is Maximum Flame (F_{MAX}) when the Current Temperature (T_{C}) is less than a Bottom Range Limit (BRL) and the output is Minimum Flame (F_{MIN}) when the Current Temperature (T_{C}) is greater than a Top Range Limit (TRL).

58. The gas cooking appliance according to claim 56, wherein the control output is unchanged when the Current Temperature (T_{C}) is between a Lower Range Limit (LRL) and an Upper Range Limit (URL).

59. The gas cooking appliance according to claim 56, wherein the control output is derived from a control algorithm when the Current Temperature (T_{S}) is between a Bottom Range Limit (BRL) and a Lower Range Limit (LRL) or between a Top Range Limit (TRL) and an Upper Range Limit (URL).

60. The gas cooking appliance according to claim 59, wherein the control algorithm includes the first derivative of the function of previous Current Temperature (T_{C}) values, the Current Temperature (T_{C}) value and the difference between the Current Temperature (T_{C}) value and the Set Temperature (T_{S}) value.

61. The gas cooking appliance according to claim 34, further comprising a light that is adapted to illuminate a front panel of the appliance.

62. A gas cooking appliance for connection to a source of gas including a frame supporting a cooking surface, at least one burner and an ignition system, the improvement including:
a first valve in fluid communication with the at least one burner by way of a variably controlled second valve; and
a switch in communication with the first valve, whereby actuation of the switch enables gas flow from the source to the at least one burner.

63. The gas cooking appliance according to claim 62, further comprising a thermal control comprising:
a thermal sensor mounted adjacent to the cooking surface;
an input device adapted to input a set temperature value;
an actuator in communication with the variably controlled second valve; and
a control system adapted to drive the actuator relative to output from the thermal sensor and the set temperature value.

64. A gas cooking appliance for connection to a source of gas including a frame supporting a cooking surface, at least one burner, a source of gas, and an ignition system, the improvement including:
a first valve in communication with a second valve, wherein the first valve selectively enables flow of a gas from the source to the second valve, and wherein the second valve is adapted to provide a variably controlled output to the burner.

65. The gas cooking appliance according to claim 64, further comprising a thermal control comprising:
a thermal sensor mounted adjacent to the cooking surface;
an switch adapted to input a set temperature value;
an actuator in communication with the second valve; and
a control system adapted to drive the actuator relative to output from the thermal sensor and the set temperature value.

66. A method of cooking for use with a cooking appliance including a frame supporting a burner and a cooking surface disposed adjacent to the burner; a first valve and a second valve joined together such that the first valve selectively enables a flow of a gas from a source to the second valve, the second valve enabling a variably controlled gas output to the burner and an ignition system adapted to ignite the gas adjacent to the burner, the method of cooking including the steps of:
opening the first valve;
initiating the igniter, thereby generating a flame at the burner; and
adjusting the second valve to alter the flow of gas to the burner.

67. A method of cooking for use with a cooking appliance including a frame supporting a burner and a cooking surface disposed adjacent to the burner; a first valve and a second valve joined together such that the first valve selectively enables a flow of a gas from a source to the second valve, the second valve enabling a variably controlled gas output to the burner, an ignition system adapted to ignite the gas adjacent to the burner, a thermal sensor mounted adjacent to the cooking surface, a button adapted to input set temperature data, an actuator in communication with the second valve and a control system adapted to drive the actuator, the method of cooking including the steps of:
inputting a set temperature;
monitoring data from the thermal sensor by the control system; and
adjusting the gas flow by the actuator relative to data from the thermal sensor and the set temperature.
